(19) United States
(12) Patent Application Publication
(10) Pub. No.: US 2005/0216306 A1
(43) Pub. Date: Sep. 29, 2005

(54) Evidence-based extender system

(76) Inventor: Benjamin Atkinson, Chicago, IL (US)

Correspondence Address: Susan D. Reinecke;Brinks Hofer Gilson & Lione, P.O. Box 10395, Chicago, IL, 60610, US

(21) Appl. No.: 10/808,104

(22) Filed: Mar. 24, 2004

(51) Int. Cl. G06F 17/60

(52) U.S. Cl. 705/2

(57) ABSTRACT

A system for efficiently providing professional services (an “EBE system”), which is based the concepts of evidence-based medicine and the physician extender model. The EBE system combines and expands these concepts to enable services, which traditionally could only be provided by costly professionals, to be provided by lower cost “extenders.” Under the EBE system, extenders work remotely from and under the supervision of one or more professionals according to protocols developed by the professionals. In addition, the extenders collect data on the effectiveness of the protocols. The feedback of this information to the professional allows the protocols to be monitored and updated and new protocols to be developed. The EBE system may include one or more professional modules, one or more extender modules, and an extender-based system. Further, the EBE system may include a method for providing professional services (an “EBE method”).

### BACKGROUND

Professional services are generally provided directly by licensed, highly educated and/or experienced individuals. For example, individuals seeking medical services generally must go to a licensed physician. In another example, individuals seeking legal services generally must go to a licensed attorney. Similar examples can be found in other fields, such as engineering and accounting. However, this system for providing professional services has serious disadvantages in terms of cost, availability, and service improvement.

Professionals generally charge a premium for their services. In many cases, a premium may even be charged for routine or mundane tasks. As a result, many professionals spend a good amount of time on mundane tasks, and many individuals do not seek adequate professional services due to the cost. In addition, the problems associated with the cost of providing professional services contribute to the lack of availability of these services in many locations and in some fields.

Furthermore, providing professional services only through professionals may not efficiently facilitate the advancement and improvement of the services. Professionals generally work in competition with each other. Therefore, in many cases, there is no motivation to compile and share information relating to the efficacy of particular professional services. Further, in many cases there is simply no infrastructure for compiling and sharing such information. In the field of healthcare, there have been two efforts to overcome some of the problems associated with providing professional services, evidence-based medicine (“EBM”) and the physician-extender model (the “PE model”).

The quality issues surrounding healthcare have motivated the formation of the EBM concept. In addition, the high costs and inefficient models used to deliver healthcare services have driven the organizational and legislative changes surrounding the role of PEs in the healthcare field in what is often referred to as the “PE model.”

Evidence-Based Medicine

“Evidence-based medicine (EBM) is the integration of best evidence research with clinical expertise and patient values.” D. L. Sackett, Evidence-Based Medicine: How to Practice and Teach EBM 1 (Churchill Livingstone 2000) (hereinafter “Sackett”). EBM, in its current form, consists of systematic reviews of scientific studies, which are made available to healthcare professionals in the form of published articles. The Cochrane Collections were the first notable compilation of EBM literature reviews. These review articles described studies related to disease or treatment, and evaluated the strengths of previous investigations in order to provide healthcare professionals guidance in decisions relating to the provision of healthcare services. EBM defines the randomized-controlled trial as the gold standard of medical research. By evaluating the scientific methodology and statistical strength of associations, EBM reviews provide a quantification of the reliability of research into current medical disorders and/or treatments.

Sackett describes five steps for practicing EBM (the “Sackett steps”). Step 1 includes converting the healthcare professional's need for information into an answerable question. Step 2 includes tracking down the best evidence with which to answer that question. Step 3 includes critically appraising that evidence for its validity, impact, and applicability. Step 4 includes integrating the critical appraisal with the clinical expertise and the patient's unique biology, values, and circumstances. Step 5 includes evaluating the effectiveness and efficiency achieved while executing steps 1 through 4, and seeking ways to improve the effectiveness and efficiency. Critical evaluation of EBM has revealed several aspects of the same problem. For example, it has been said that “EBM as it is defined today, paints only with a broad brush and in a restricted reductionist way.” P. E. Petros, “Non-linearity in clinical practice,” Journal of Evaluation in Clinical Practice, 2003, at 2, 9, 171-178.

These quotes support the view that in the current implementations of EBM, the data collected or analyzed is not sufficient to allow meaningful modifications to be made to healthcare services, such as diagnoses and treatment decisions. EBM is essentially statistical process control without the statistics. For example, consider a typical randomized-control study, which may involve 80 patients, 40 of which are in treatment and 40 of which are in a control group. From this study, it may be possible to calculate the relative strengths of the associations between the treatments and the outcomes. However, these results are so limited by the specific parameters of the study that when extrapolated outside the parameters of the study, the results are almost useless. An irony of this situation is that the ability to assign values to associations is made possible because of the limits assigned in the design of such a study. In other words, the limits are necessary for the collection and analysis of data in a reasonable amount of time.

Another aspect of the problem with EBM is the paradox of the general and the particular. This conundrum has plagued the healthcare field for millennia. In general, the paradox of the general and the particular arises from the conflict between providing healthcare on behalf of a patient (the particular), and on behalf of society (the general), simultaneously. This paradox expresses the dilemma encountered when one attempts to extend knowledge gained from a particular medical case to a general class of cases, or applying results from a population study to the individual. This paradox has led to the science-art concept of medicine, in which the science is concerned with general medical knowledge and the art is concerned with the application of treatment to the individual. This leaves a chasm between EBM and the healthcare professionals, blunting the principles of EBM by restricting the value of the information flowing between the general and the particular.

Another aspect of the problem with EBM is that it applies a linear approach to a non-linear system. Biological systems are inherently non-linear. That is, relationships in biological systems are complex, and an event in one area is not transferred linearly to another area. Instead, the impact of an event sets off a cascade of effects throughout the system. Nature's complex systems have the capacity to spontaneously “self-organize” utilizing the methods requiring the lowest expenditure of energy. In contrast, modern statistical approaches rely greatly on linear models. Therefore, even with new approaches beginning to emerge from the advances in computing power, current statistical approaches (such as, the randomized-control trial) cannot possibly take into account sufficient variables to make useful predictions. The tools of medical research and the scale of research capabilities haven't changed dramatically since the 18^{th} century.

Physician Extender Model

For decades, the use of physician extenders (“PEs”) has helped free physicians and other healthcare professionals from the more mundane aspects of healthcare, allowing them more time to provide the more complicated and/or urgent healthcare services. Examples of PEs that have been utilized in the clinical setting to perform the more routine medical tasks include the physician assistant (“PA”) and nurse practitioner (“NP”). Other non-physician healthcare providers, such as a physical therapist (“PT”) and certified athletic trainer (“ATC”) have been serving as PEs (generally within the realm of physical medicine) and have been doing so since World War I.

The PE model provides many efficiencies because the PE model allows certain healthcare services, such as routine evaluations and treatment tasks, to be delegated to PEs who generally require less training and demand less pay than physicians. Because of its efficiency, the PE model has been touted as a solution to the misdistribution of certain healthcare services in disadvantaged communities and rural locales.

However, within the PE model, it may be very difficult to define a practice scope for the PEs. One cause of this difficulty is the conflict between the autonomy of the PE and the hegemony of the physician. In general, many physicians can accept the usefulness of PEs, as long as the PEs stay out of the more desirable practice areas. Legalities add to the difficulty in defining a practice scope for PEs. For example, state laws vary greatly with regard to PEs. Although many states allow PEs a relatively wide practice scope, if they practice under the supervision of a physician, the definition of “supervision of a physician” varies from state to state. Another factor contributing to the difficulty in defining the practice scope for PEs is that while some federal programs (such as Medicaid & Medicare) recognize services rendered by PEs as legitimate and reimbursable, some managed care and other insurance entities do not always provide the same recognition.

### BRIEF SUMMARY

In view of the shortcomings of the EBM and PE models, it would be desirable to provide a system to effectively provide medical, as well as other professional services. Such a system (an “evidence-based extender system” or “EBE system”), which is based on concepts from the healthcare field, has been developed. The evidence-based extender system uses the concepts of evidence-based medicine (“EBM”) and the physician extender (“PE”) model, and combines and expands them to enable services, which traditionally could only be provided by costly professionals, to be provided by lower cost providers referred to as “extenders.” By exploiting the quality provided by EBM and the efficiencies provided by the PE model, the EBE system allows extenders to work remotely from and under the supervision of one or more professionals. In the EBE system, the extenders provide the professional services according to instructions for providing professional services (“protocols”) that are developed by the professionals. In this manner, the extenders enable the professionals to “extend” their reach beyond those clients, customers, patients or other recipients of professional services (referred to collectively in this document as “recipients”) that the professional can handle personally, as well as to remote locations.

The EBE system also provides for a useful and seamless flow of information that can be used not only to provide professional services, but to improve these services as well. For example, the EBE system enables statistically significant data on the effectiveness of the protocols to be gathered, compiled, and communicated to the professional. Because the extenders collect data on the effectiveness of the protocols, they therefore become data collectors or researchers for the professional. The feedback of this information to the professional allows the protocols to be consistently monitored and updated. Further, the EBE system involves the recipient directly in the research, enables the provision of better professional services and a greater number of professional service options. In addition, the EBE system reduces the discrepancy between general knowledge and the individual application.

The EBE system may include one or more professional modules, one or more extender modules, and an extender-based (EB) system. The extender modules and the professional modules generally serve as interfaces to the EB system for the extenders and professionals, respectively. The professional modules may be used by professionals to enter protocols for providing professional services onto the EB system. The extender modules may be used by the extenders to enter information relating to the services needed by a recipient (the “need data”), and relating to the application of the protocols in providing the professional services (“protocol application data”). The EB system may include a protocol module. The protocol module may store protocols entered by the professionals. In addition, the protocol module may include an efficacy module and a protocol selection module. The protocol selection module may determine which of the protocols are appropriate (the “appropriate protocol” or “appropriate protocols”) in view of the need data. The protocol efficacy module may determine the efficacy of the protocols from the protocol application data. The efficacy of the protocols may be accessed by the professionals via a professional module and used to improve and update the protocols and/or develop additional protocols.

The EBE system enables a flow of information that generally starts with the professional. The professional develops one or more protocols for providing professional services, and communicates the protocols to the EB system. Upon communication of need data from an extender, the EB system may select and communicate one or more appropriate protocols to the extender. The extender may supply information back to the EB system before (generally as need data), during and/or after providing the professional service (generally as protocol application data) via extender feedback loop. Then, via a professional feedback loop, the EB system may compile, evaluate and/or supply this information back to the professional, who may accordingly modify one or more of the protocols or create one or more additional protocols. The flow of information is also possible without the EB system. For example, the professional may be in communication with the extender according to some other mechanism, such as verbally or in writing. In this case, the functions of the EB system may be performed by the professional, an extender and/or another party.

The EBE system may include a method for providing professional services (an “evidence-based extender method” or “EB method”) that is also based on the concepts of EBM and the PE model. The EBE method may include the following general steps: developing protocols and entering them into the EB system; determining and selecting the appropriate protocol; providing professional service according to the selected appropriate protocol; adjusting the selected appropriate protocol as appropriate; updating the selected appropriate protocol as appropriate; and repeating the EBE method as appropriate.

Other systems, methods, features and advantages of the invention will be, or will become, apparent to one with skill in the art upon examination of the following figures and detailed description. It is intended that all such additional systems, methods, features and advantages be included within this description, within the scope of the invention, and protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 is a block diagram of an evidence-based extender system;

FIG. 2 is a block diagram of the flow of information in an evidence-based extender system; and

FIG. 3 is a swimlane representation of an evidence-based method for providing a service through an extender.

### DETAILED DESCRIPTION

The healthcare field is an excellent field in which to find solutions to the problem of efficiently providing professional services. One reason being that without question, one of the most pressing societal concerns is health. Health has become the new salvation for a generation dispossessed of philosophical and theological dogma. In addition, technology has drawn into sharper focus myriads of conditions and disorders that went unnoticed or were simply accepted even a few decades ago. The result is that modern societies are increasingly unwilling to accept gaps between the capability and the accessibility of healthcare services. With ever more attention focused on health, a growing market has been created, into which more and more money is being poured. However, growing markets are often rife with inefficient and inconsistent quality in the production or provision of services.

Evidence-based medicine (“EBM”) defines a useful model for improving the quality of healthcare services. In addition, EBM may be applied to the provision of other professional services, because many professional services involve the same problem-identifying and solving steps outlined by traditional EBM. Unfortunately, EBM, whether applied to healthcare or other professional services, is limited by barriers to information flow and data compilation. However, modern technology can be used to overcome these barriers in conjunction with another emerging healthcare concept, the physician extender (“PE”) model.

Like EBM, the PE model may be applicable to other professional fields. For example, technicians can provide some of the services of engineers, while working under the supervision of an engineer. In another example, some legal services may be provided by paralegals working under the supervision of an attorney. These and other professions could enjoy the same benefits enjoyed by the healthcare profession by using “extenders.” No matter the field in which it is used, the PE model may be “supercharged” by utilizing current technology. Recent advances in communication technologies may be used to enable extenders to provide professional services under the supervision of a professional, remotely. Therefore, modern technology could now be used to extend the reach of the extenders.

The concepts of EBM and the PE model were formed independently of each other and have separately created new possibilities for the advancement and distribution of healthcare. However, in combination, the concepts of EBM and the PE model create new possibilities for the advancement and provision of professional services in general. In addition, when EBM and the PE model are combined, the merits are synergistic, while critical flaws are resolved. It is only recently that technology has made the uniting of these concepts possible.

Evidence-Based Extender System

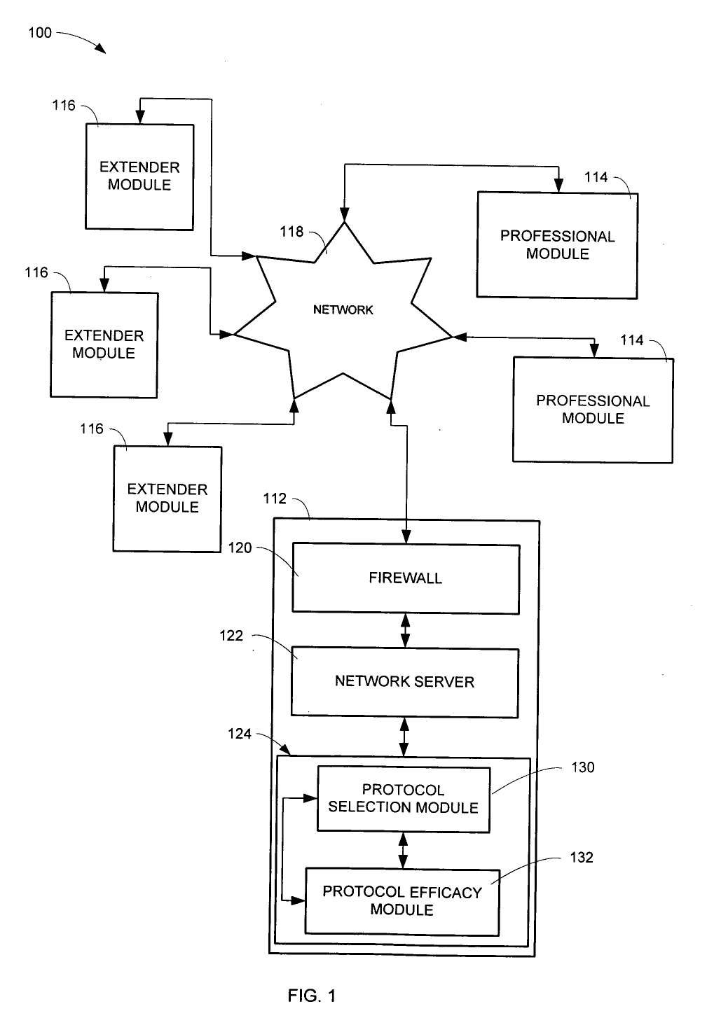

One example of an evidence-based extender (“EBE”) system is shown in FIG. 1 and indicated by reference number 100. The EBE system 100 may include one or more professional modules 114, one or more extender modules 116, an extender-based (“EB”) system 112 and a network 118. The EBE system provides for a useful and seamless flow of information that can be used not only to provide professional services, but to improve these services as well.

The extender modules 116 and the professional modules 114 generally serve as an interface to the EB system 112, to which they may be directly coupled or indirectly coupled through the network 118. The extender modules 116 and the professional modules 114 may be any type of computer, terminal, personal digital assistant (“PDA”), cellular phone or any device capable of digital communication. The extender modules 116 and the professional models 114 may communicate with the network 118 and/or the EB system 112 using any type of electromagnetic communications via any type of electromagnetic channel or network. The extender modules 116 and the professional modules 114 may or may not be of the same type. Although three extender modules 116 and two professional modules 114 are shown in FIG. 1, there may be any number of extender modules 116 or professional modules 114.

The EB system 112 may include a protocol module 124. This protocol module may include a protocol selection module 130 in communication with a protocol efficacy module 132. The protocol selection module 130 may include computer software for determining one or more protocols that are appropriate for a given situation. The given situation is assessed and summarized into “need data” by an extender. The extender then communicates the need data to the EB system 112 via an extender module 116. The protocol selection module 130 may then choose one or more protocols appropriate for the need data (the “appropriate protocol” or “appropriate protocols”) from among protocols stored within the EB system 112. The protocol selection module 130 may determine the appropriate protocols according to a decision-making system. This decision-making system may include a problem-solving system, a pattern recognition system, a rule-based system, or a combination of these. The decision-making systems are all generally microprocessor or computer-based and make decisions based on the need data.

A problem-solving system involves describing phenomena, categorizing the phenomena and building theories to explain the phenomena. Once a theory has been created; the theory may be refined through research, reporting and peer review. If the theory is sound it becomes paradigmatic. Developing the paradigm may require input from experts in multiple disciplines. However, although a multidisciplinary team may be required to create and refine the theory, once the theory becomes a paradigm, the theory and associated knowledge may be made available for application.

A pattern-recognition system involves applying existing knowledge to an observed pattern or phenomenon. The pattern-recognition system may use a current paradigm and add to it the results of extensive application and new technology. In this manner, current techniques may be improved and, therefore, application of the paradigm becomes more efficient and effective as the techniques improve. For example, recognition of specific conditions or phenomenon becomes easier as the techniques advance. The techniques may become available for application.

A rule-based system generally allows the application of specific solutions to specific problems. Due to the paradigmatic nature of knowledge in a specific field and advances in technology, the extender can apply rules developed by professionals, which guide the extender through the collection of need data and application of the appropriate protocol. Rules allow the professional to extend their knowledge for a predefined set of circumstances or needs.

Each of these systems is generally adequate for situations involving a different level of complexity and generally requires a different level of professional skill and service. This may be explained using an example from the healthcare field. For example, a rule-based system may be adequate for situations involving simple disorders, which are generally limited to one body part or system, such as, a shoulder strain or simple infection. A pattern recognition system may be adequate for situations involving more complicated disorders, which may require the recognition of symptoms in multiple systems, such as diabetes. In contrast, however, a problem-solving system may be required for more complicated situations, which may involve multiple conditions or disorders and/or obscure and/or diffuse etiology. One example of a problem-solving system is an expert system (also known as artificial intelligence or AI). An expert system generally includes a computer program that can simulate the judgment and behavior of a human or organization that has expert knowledge and experience in a particular field. An expert system may also include a knowledge base containing accumulated experiences and a set of rules for applying the knowledge base to each particular set of conditions.

The protocol efficacy module 132 may include computer software for determining the efficacy of the protocols. The efficacy of the protocols may be determined from data relating to the application of the protocols in providing the professional services (“protocol application data”). For example, if the EBE system 100 is implemented in the medical field, the protocol application data may relate to progress reports and final evaluations of patients treated according to the various protocols. The protocol efficacy module 132 may accumulate the protocol application data and apply statistical analysis to assign a relative efficacy score to each protocol. The protocol efficacy module 132 may recognize, store and/or communicate patterns or trends in the protocol application data. The protocol efficacy module 132 may be in communication with the protocol selection module 130. Information supplied by the protocol efficacy module 132 relating to the relative efficacies of the protocols (“efficacy information”) may be used by the protocol selection module 130 in determining the appropriate protocols for a particular set of need data. In addition, the efficacy information may be used by the professional to improve or update one or more of the protocols, and/or develop one or more new protocols.

The EB system 112 may also include a network server 122 and/or a firewall 120. The network server 122 may provide an interface between the EB system 112 and the network 118 and/or the extender modules 116 and/or the professional modules 114. The network server 122 may be in communication with the network 118, directly or indirectly through the firewall 120, or directly with the extender and/or professional modules, 116 and 114, respectively. The firewall 120 may provide a buffer between the EB system 112 and the network 118, extender modules 116, and/or the professional modules 114. The firewall 120 may be coupled between the network server 122 and the network 118 or the extender and/or professional modules, 116 and 114, respectively. Alternately, the firewall 120 may coupled between the protocol module 124 and the network 118 or the extender and/or professional modules, 116 and 114, respectively.

The extender modules 116, professional modules 114, and the EB system 112 may, separately or in any combination, include an input device (not shown) and an output device (not shown). The output device may be any type of visual, manual, audio, electronic, or electromagnetic device capable of communicating information from a processor or memory to a person or other processor or memory. Examples of output devices include, but are not limited to, monitors, speakers, liquid crystal displays, networks, buses, and interfaces. The input device may be any type of visual, manual, mechanical, audio, electronic, or electromagnetic device capable of communicating information from a person, or memory to a processor or memory. Examples of input devices include keyboards, microphones, voice recognition systems, trackballs, mice, networks, buses, and interfaces. Alternatively, the input and output devices may be included in a single device such as a touch screen, computer, processor or memory coupled with the processor via a network. The extender modules 116, professional modules 114, and the EB system 112, separately or in any combination, may further include one or more processors and one or more computer-readable memory devices (not shown). The memory devices may be any type of fixed or removable digital storage device and, if needed, a device for reading the digital storage device including, floppy disks and floppy drives, CD-ROM disks and drives, optical disks and drives, hard-drives, RAM, ROM and other such devices for storing digital information. The processor may be any type of device or devices used to process digital information. In addition, the input and output devices may also include computer software that enables communication among the extender modules 116, professional modules 114 and the EB system 112 directly, or through the network 118, and between the extender modules 116, professional modules 114 and/or the EB system 112 and a user or other system.

The extender modules 116, professional modules 114 and the EB system 112 may communicate with each other via the network 118. The network may include public networks, such as the Internet, and/or private networks, often referred to as “intranets,” local area networks (LANs), wide area networks (WANs), virtual private networks (VPNs), and frame relay or direct telephone connections.

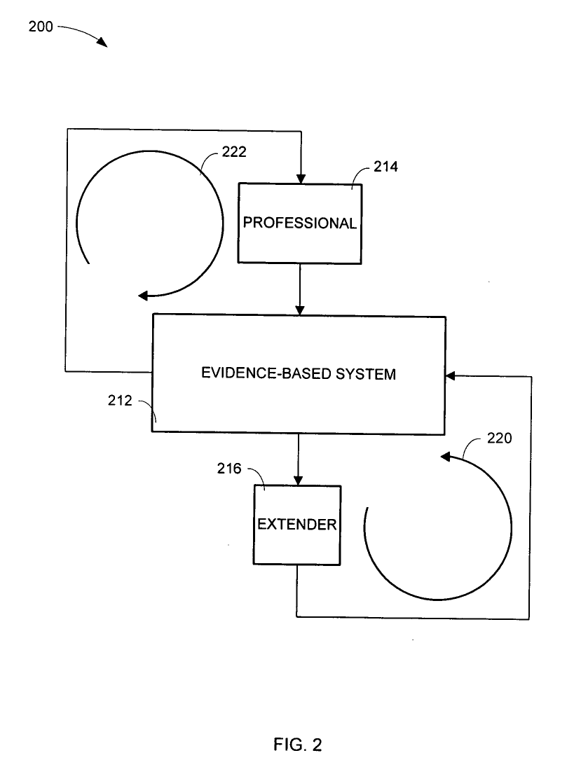

A simplified diagram of the flow of information in the EBE system is shown in FIG. 2 and indicated by reference number 200. In general, the information flows from a professional 214 to an EB system 212, to an extender 216, back to the evidence-based system 212 and the professional 214. Although only one extender 216 and one professional 214 are shown, the EBE system may include any number of extenders and professionals, with the flow of information being similar to that shown in FIG. 2. The flow of information may be continuous or intermittent and may repeat any number of times. In addition, there may be any number of information flows occurring simultaneously and/or sequentially.

In general, the information flow starts with the professional 214 who develops one or more protocols for providing professional services. The professional 214 communicates the protocol, generally using a professional module (see FIG. 1, reference number 114) to the EB system 212. Upon communication of need data from an extender 216, the EB system 212 may select and communicate the protocol to the extender 216. Communication to and from the extender 216 may be made using an extender module (see FIG. 1, reference number 114). The extender 216 may supply information back to the EB system 212 before (generally as need data), during and/or after (generally as protocol application data) providing the professional service via extender feedback loop 220. Then, via a professional feedback loop 222, the EB system 212 may compile, evaluate and/or supply this information back to the professional, who may accordingly modify one or more of the protocols or create one or more new protocols. The flow of information is also possible without the EB system 212. For example, the professional 214 may be in communication with the extender 216 according to some other mechanism. For example, they may communicate verbally or in writing. If the EB system 212 is not included in the EBE system, the professional 214, extender 216 and/or a third party may perform the functions performed by the EB system 212.

To better illustrate the EBE system, examples from the medical field will be presented. However, the EBE system may be implemented for any profession. The following example illustrates the operation of the EBE system when no EB system is involved. This example involves the realm of physiotherapy. A physician specializing in physical medicine (a physiatrist) may treat musculoskeletal disorders. In reality, the majority of patients he treats do not tax his medical knowledge greatly. In fact, he has developed a system of protocols for 85% of the conditions he sees. These protocols provide specific treatment instructions for a certified athletic trainer (ATC) located at the physiatrist's clinic. The ATC, using these treatment instructions, is able to evaluate and treat a wide range of conditions without directly involving the physiatrist. However, should the ATC's evaluation or feedback from a patient reveal a condition or situation that is outside the ATC's scope of practice or the scope of the protocols, an appropriate referral is indicated by the protocols. For example, the ATC may be instructed by the protocols to refer the patient to the physiatrist. As long as the ATC is treating within the confines of the protocols provided, the ATC may be considered as working under the supervision of a qualified physician. This greatly increases the efficiency of the clinic.

Referring to FIG. 1, the following example illustrates the operation of the EBE system 100 when an EB system 112 is included. This example uses the same situation as in the previous example, except that in this example, the ATC is located at a fitness facility across town from the professional, and has access to an EB system 112 via an extender module 116. When a member at the fitness facility strains his shoulder while working out, the ATC evaluates the patient at the fitness facility and compiles need data from the results of the evaluation. The need data may include information regarding the patient's symptoms and characteristics, and the circumstances surrounding the injury. The extender (ATC) then enters the need data into the extender module 116. The extender module 116 is in communication with an EB system 112, which is in communication with a professional module 114 located in the professional's (in this example, the physiatrist's) clinic. The communication may be provided by a network 118 such as the Internet. In response to the ATC's entry of the need data, the EB system 112 determines the appropriate protocol for treating the patient's injury and communicates this appropriate protocol to the ATC via the extender module 116. The ATC may treat the patient (providing the professional service) immediately according to the appropriate protocol. As in the previous example, the professional is not directly involved. However, the patient received immediate care for his condition at a point of treatment located at the place of injury. In addition to the setting just described, the EBE system 100 enables effective treatment by PEs at many points of treatment, such as: occupational medicine facilities, hospitals, long-term care facilities, sports medicine facilities, military healthcare facilities, and virtually any location.

Again referring to FIG. 1, the following example illustrates some of the advantages provided by the flow of information and the economy of scale enabled by the EBE system 100. Again, consider the ATC located at the fitness facility. This extender may treat about 20 patients each day. During patient evaluations, the ATC collects need data, which may include information about the patient such as, personal characteristics and medical test results. The ATC may then communicate the need data to the EB system 112 using the extender module 116 and perhaps, a network 118. In addition, the ATC may also gather and enter information relating to treatment and for each follow up visit (protocol application data) into the extender module. Now, extend this example to include 1,000 similarly situated ATCs, each treating about 20 patients per day. With 1,000 extenders at remote locations utilizing the same EBS system 112 via extender modules 116, an unprecedented diagnostic and predictive power emerges. By capturing need data and protocol application data, which may include patient characteristics, medical test results, treatments applied, outcomes achieved, and follow-up information for 20,000 patients each day, the concept of EBM suddenly has muscle. By analyzing the information gathered for each protocol, these same protocols can be constantly refined and new protocols may be developed. This provides new and/or improved options for the extender, the patient and the professional.

Another example of an advantage provided by the flow of information and the economy of scale enabled by the EBE system 100 is the personalization of service. Modern medicine, in spite of great strides in all areas of technology, is often practiced under the philosophies of “one size fits all” and “wait and see.” Often very dissimilar patients will receive the same treatment for a similar condition. To illustrate this point, an example in the area of physiotherapy will be given. A 25-yr-old athletic male and 54-yr-old diabetic female are evaluated and prescribed treatment for epicondylitis (otherwise known as “tennis elbow”). Using traditional methods for providing professional services, these two individuals are likely to be given the same treatment regimen by a professional. The professional will then “wait and see” to discover each patient's response to the treatment. This approach is used because the sufficiently detailed investigations of the differences in treatment responses of dissimilar patients, which are required to develop more specific treatment protocols, have not been performed.

However, consider the previous example, except that an ATC has access to an EBE system 100, which includes an EB system 112 to which the ATC is in communication via an extender module 116. In this case, it is possible to develop or refine protocols according to a variety of patient characteristics due to the large amount of information that can be gathered by the multiple extenders. Therefore, the ATC has access to specific protocols relating to his patient's condition and personal characteristics and can use different protocols for the 25-yr-old athletic male and 54-yr-old diabetic female. This level of detail greatly increase the quality of care a patient receives.

Another advantage provided by the flow of information and the economy of scale enabled by the EBE system 100 is the creation of professional service options for the recipient. When protocol application data can be collected in statistically significant amounts, multiple protocols and their associated efficacy rates can be determined and offered to the recipient. The recipient is thus enabled to choose a protocol that best fits the recipient's particular situation. In another medical example, the EB system 112 indicates that a patient has tendonitis and may accordingly select an appropriate protocol that includes treatment specifically for tendonitis and for the patient's particular characteristics. Further, the EB system 112 may select multiple appropriate protocols and may communicate these appropriate protocols and the efficacy information relating to each to the ATC. For example the EB system 112 may communicate the following appropriate protocols and their efficacy information: (1) 3 weeks of clinical treatment and home exercises, which has an 87% efficacy rate; (2) 5 weeks of clinical treatment, which has a 90% efficacy rate; or (3) 7 weeks of home exercises, which has a 93% efficacy rate. The patient, alone or with the help of the ATC, may then choose the appropriate protocol that best fits her situation. For example, the patient may need to recover quickly, to be ready for softball season. In this case, the patient may chose protocol (1), which includes a 3-week intensive treatment for quicker recovery. In another example, cost may be a concern for the patient. Therefore, the patient may choose protocol (3), which includes a longer treatment time, but involves only no cost or low cost at-home exercise.

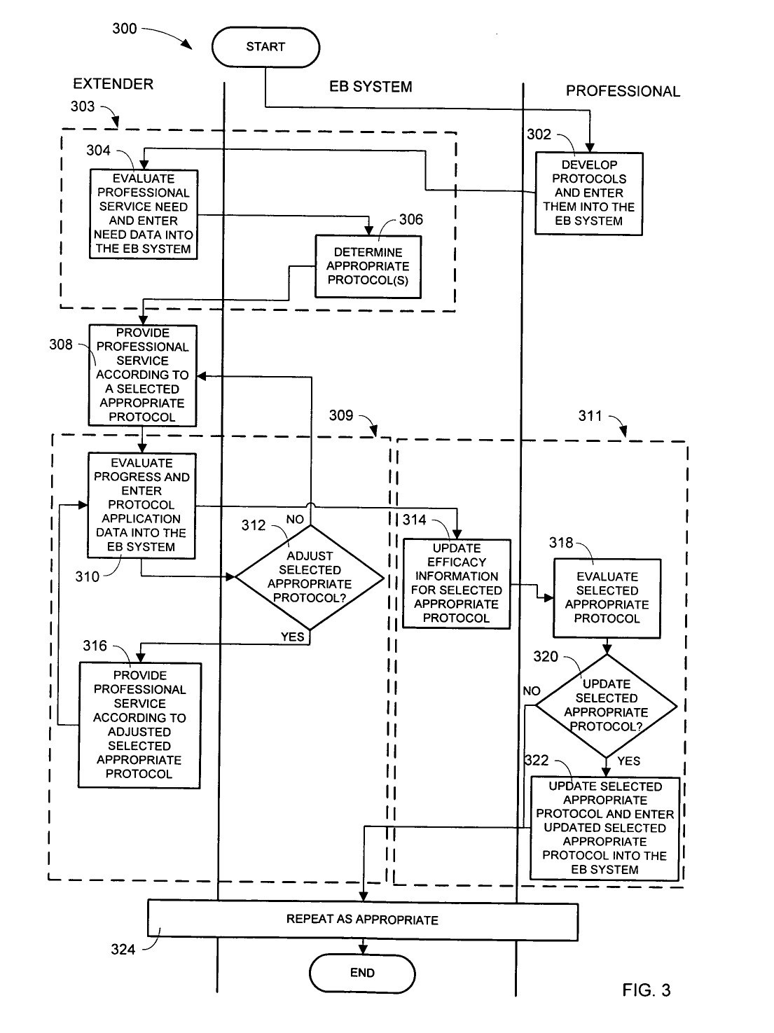

An example of a method enabled by an EBE system (an “evidence-based extender method” or “EBE method”) that includes an EB system is shown in FIG. 3. The EBE method 300 is shown in a swimlane representation. Therefore, FIG. 3 includes “swimlanes” separated by vertical lines. These swimlanes are included for the sole purpose of illustrating which entity performs which step and are not part of the EBE method. In FIG. 3, the extender swimlane, which includes all blocks to the left of the left-most vertical line, includes an example of the steps that may be performed by one or more extenders in the EBE method. The center swimlane, which includes all blocks between the two vertical lines, includes an example of the steps that may be performed by an EB system in the EBE method. The right swimlane, which includes all blocks to the right of the right-most vertical line, includes an example of the steps that may be performed by one or more professionals in the EBE method. The EBE method 300 may include the following general steps: developing protocols and entering them into the EB system 302; determining and selecting an appropriate protocol 303; providing a professional service according to the selected appropriate protocol 308; adjusting the selected appropriate protocol as appropriate 309; updating the selected appropriate protocol as appropriate 311; and repeating the EBE method as appropriate 324.

Developing protocols and entering them into an EB system 302, is generally performed by one or more professionals. The protocols generally include the appropriate steps for performing a professional service and the situations, and parameters under which the protocol may be performed. The steps and situations are generally worded so that a generally less experienced and/or educated PE can understand and perform them. The protocols are generally developed based on the experience and expertise of the professional or a group of professionals. Although developing protocols is performed by the professional(s), the protocols may be entered into the EB system by anyone, including an extender, assistant or other party.

Determining and selecting the appropriate protocol 303 may include evaluating a professional service need and entering need data into the EB system 304; and determining the appropriate protocol(s) 306. Evaluating a professional service need 304 is generally performed by the extender. The extender will evaluate the recipient's situation, which may include symptoms, requirements, specifications or other needs, and compile need data for the recipient. This need data may then be entered into the EB system 304, generally via an extender module (see FIG. 1, reference number 116). Using the protocol selection module (see FIG. 1, reference number 130) and perhaps information from the protocol efficacy module (see FIG. 1, reference number 132), the EB system determines one or more protocols appropriate for the entered need data (one or more “appropriate protocols”). The appropriate protocols may then be communicated to the extender generally via an extender module (see FIG. 1, reference number 116). In some cases, such as when the entered need data indicates a situation outside the parameters of the protocols in the EB system, the EB system may indicate that the extender is to refer the recipient to a professional to receive the professional services.

In some, the EB system may indicate multiple appropriate protocols. In this case, determining and selecting the appropriate protocol 303 may further include the recipient and/or the extender selecting one of the multiple appropriate protocols (not shown). The appropriate protocol that is to be used by the extender to provide the professional service is designated the “selected appropriate protocol.” The selected appropriate protocol may be chosen to fit the particular circumstances or situation of the recipient, such as time, monetary and other factors. The step of actually providing the professional service according to a selected appropriate protocol 308 is generally performed by the extender.

Adjusting the selected appropriate protocol as appropriate 309 may include evaluating progress and entering protocol application data into the EB system 310; determining whether to adjust the selected appropriate protocol 312; if it is determined not to adjust the selected appropriate protocol, repeating steps 308, 310 and 312 as appropriate; and if it is determined to adjust the selected appropriate protocol, providing the professional service according to the adjusted selected appropriate protocol 316. Evaluating progress and entering protocol application data into the EB system 310 is generally performed by the extender. The extender reviews the results of applying the selected appropriate protocol at various times and collects data related to that progress (the protocol application data). The extender then may enter the protocol application data into the EB system. Using the protocol module (see FIG. 1, reference number 124) the EB system evaluates the protocol application data and determines whether the selected appropriate protocol needs to be adjusted 312. If the EB system determines that the selected appropriate protocol does not need to be adjusted, the extender may continue to provide the professional service according to the selected appropriate protocol 308 and continue with the steps of the EBE method until the selected appropriate or an adjusted selected appropriate protocol (determined to be need by the EB system at a later time) indicates that the professional service is to end. However, if the EB system determines that the selected appropriate protocol needs to be adjusted, the EB system will adjust the selected appropriate protocol (creating an “adjusted appropriate protocol”), which may include providing a new selected appropriate protocol, and communicate the adjusted appropriate protocol to the extender. The extender will then provide the professional service according to the adjusted appropriate protocol 316, and may continue with the steps of the EBE method until the selected appropriate or an adjusted selected appropriate protocol indicates that the professional service is to end.

Updating the selected appropriate protocol as appropriate 311 may include updating the efficacy information for the selected appropriate protocol 314; evaluating the selected appropriate protocol 318; determining whether to update the selected appropriate protocol 320; if it is determined to update the selected appropriate protocol, updating the selected appropriate protocol and entering the updated selected appropriate protocol into the EB system 322. Using the protocol efficacy module (see FIG. 1, reference number 132) and the protocol application data entered by the extender and any other extenders for the selected (or adjusted selected) appropriate protocol, the protocol efficacy module (see FIG. 1, reference number 132) recomputes the efficacy information for the selected appropriate protocol 314. The professional may then evaluate the selected (or adjusted selected) appropriate protocol in terms of its updated efficacy information 318.

Based on the updated efficacy information, the professional may decide whether to update the selected (or adjusted selected) appropriate protocol 320. The professional may decide to update the selected (or adjusted selected) appropriate protocol or any of the other protocols in the EB systems based on new applications of science and/or technology to their field or any other reason. In addition, new protocols may be introduced. Because the updated selected (or adjusted selected) appropriate protocol and new protocols may be applied to many recipients by many extenders, each of whom are gathering need data and protocol application data, the EB system will provided unprecedented opportunities for innovation in many fields by extending the scope of protocol testing and evaluation.

If the professional determines that the selected (or adjusted selected) appropriate protocol should be updated, the selected (or adjusted selected) appropriate protocol is updated and the updated selected appropriate protocol is entered into the EB system 322. After the updated selected appropriate protocol is entered into the EB system, or it is determined that the selected (or adjusted selected) appropriate protocol is not to be updated 320, the EBE method may be repeated as appropriate 324.

Alternately, the EBE method may be implemented without the EB system. Although the automation provided by the EB system offers many efficiencies, the steps performed by the EB system may be performed by the extender, professional, other party, or combination of the foregoing.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. An evidence-based extender system, comprising:
a professional module through which a plurality of protocols for providing a professional service are communicated;
an extender module through which data relating to the recipient's need for the professional service are communicated; and
an evidence-based system in communication with the professional module and the extender module, receiving the plurality of protocols and the data, and selecting a protocol from among the plurality of protocols according to the data thus defining a selected protocol.

2. The system of claim 1, further comprising an extender feedback loop in communication with the extender module and the evidence-based system.

3. The system of claim 1, further comprising a professional feedback loop in communication with the evidence-based system and the professional module.

4. The system of claim 1, wherein the evidence-based system includes a protocol module in communication with the extender module and the professional module.

5. The system of claim 4, wherein the protocol module includes a protocol selection module that selects the one or more protocols.

6. The system of claim 4, wherein the protocol module includes a protocol efficacy module that determines an efficacy of the plurality of protocols.

7. The system of claim 6, wherein the protocol efficacy module is in communication with a protocol selection module, where the protocol selection module selects the one or more protocols according to the efficacy of the plurality of protocols.

8. An evidence-based extender system, comprising:
a means for communication a plurality of protocols for providing professional services;
a means for selecting a protocol from among the plurality of protocols, thus defining a selected protocol, wherein the means for selecting is in communication with the means for communicating; and
a means for receiving the selected protocol in communication with the means for selecting.

9. An evidence-based system for providing a professional service to a recipient through an extender according to a protocol, comprising:
a protocol selection module receiving a plurality of protocols and data relating to the recipient's need for the professional service and selecting the protocol from among the plurality of protocols according to the data relating to the recipient's need for the professional service; and
an extender feedback loop in communication with the protocol selection module and the extender and communicating the data relating to the recipient's need for the professional service to the protocol selection module.

10. The system of claim 9, further comprising a protocol efficacy module receiving data relating to an efficacy of the plurality of protocols and in communication with the protocol selection module, and the protocol selection module selects the protocol from among the plurality of protocols further according to the data relating to the efficacy of the plurality of protocols.

11. A computer readable medium comprising computer-executable instructions for implementing an evidence-based extender system for providing a professional service to a recipient through an extender, the evidence-base extender system comprising:
a protocol selection module receiving a plurality of protocols and data relating to the recipient's need for the professional service, and selecting the protocol from among the plurality of protocols according to the data relating to the recipient's need for the professional service; and
an extender feedback loop in communication with the protocol selection module and the extender and communicating the data relating to the recipient's need for the professional service to the protocol selection module.

12. An evidence-based method for providing a professional service to a recipient through an extender, comprising:
providing a plurality of protocols relating to the professional service;
collecting data from the recipient relating to a need for the professional service, thus creating need data;
selecting a protocol from among the plurality of protocols according to the need data, thus defining a selected protocol; and
providing the professional service to the recipient through the extender according to the selected protocol.

13. The method of claim 12, wherein the need data is collected by the extender.

14. The method of claim 12, wherein the selected protocol is selected by an evidence-based system.

15. The method of claim 14, further comprising providing a professional module, through which the plurality of protocols are provided to the evidence-based system.

16. The method of claim 14, further comprising providing an extender module, through which the need data are provided to the evidence-based system.

17. The method of claim 12, further comprising collecting data relating to a provision of the professional service according to the selected protocol, thus creating protocol application data.

18. The method of claim 17, further comprising determining an efficacy of the plurality of protocols as a function of the protocol application data.

19. The method of claim 17, wherein the protocol application data is collected by the extender.

20. The method of claim 17, further comprising adjusting the selected protocol to create an adjusted protocol in response to the protocol application data.

21. The method of claim 20, wherein the selected protocol is adjusted by an extender-based system.

22. The method of claim 20, wherein providing the professional services through the extender includes providing the professional services according to the adjusted protocol.

23. A method for providing a medical service to a patient through a physician extender, comprising:
providing a plurality of treatment protocols relating to the medical service;
collecting data from the patient relating to a need for the medical service, thus creating need data;
selecting a treatment protocol from among the plurality of treatment protocols according to the need data; and
providing the medical service to the patient through the physician extender according to the treatment protocol.

24. A computer readable medium comprising computer-executable instructions for performing an evidence-based method for providing a professional service to a recipient through an extender, the evidence-based method comprising:
receiving a plurality of protocols and data relating to the recipient's need for the professional service;
selecting a protocol from among the plurality of protocols according to the data, thus defining a selected protocol; and
communicating the selected protocol to an extender for providing the professional service to the recipient according to the selected protocol.
